(19) United States
(12) Patent Application Publication
(10) Pub. No.: US 2023/0273842 A1
(43) Pub. Date: Aug. 31, 2023

(54) METHOD OF GENERATING SCREENSHOT AND ELECTRONIC DEVICE PERFORMING THE METHOD

(71) Applicant: SAMSUNG ELECTRONICS CO., LTD., Suwon-si (KR)

(72) Inventors: Jaesung PARK, Suwon-si (KR); Lehoon PARK, Suwon-si (KR)

(21) Appl. No.: 18/312,105

(22) Filed: May 4, 2023

Related U.S. Application Data
(63) Continuation of application No. PCT/KR2023/001441, filed on Feb. 1, 2023.

(30) Foreign Application Priority Data
Feb. 28, 2022 (KR) 10-2022-0025875
Mar. 24, 2022 (KR) 10-2022-0036592

(51) Int. Cl. G06F 9/54; G06T 1/00; G06F 3/0484

(52) U.S. Cl. CPC G06F 9/543; G06F 3/0484; G06T 1/0007

(57) ABSTRACT

A method of generating a screenshot and/or an electronic device for performing the method may be provided. The electronic device may include a display module including at least one display, at least one processor, and a memory electrically connected to the at least one processor and configured to store instructions executable by the processor, wherein the processor is configured to, when the instructions are executed, generate a screenshot by capturing a screen output on the display module, determine metadata associated with the screenshot, and store the screenshot and the metadata in the memory, wherein the metadata may include a path configured to output the screen when the screenshot is captured.

### CROSS-REFERENCE TO RELATED APPLICATIONS

This application is a continuation application of International Application No. PCT/KR2023/001441 designating the United States, filed on Feb. 01, 2023, in the Korean Intellectual Property Receiving Office and claiming priority to Korean Patent Application No. 10-2022-0025875, filed on Feb. 28, 2022, and Korean Patent Application No. 10-2022-0036592, filed on Mar. 24, 2022, in the Korean Intellectual Property Office, the disclosures of which are incorporated by reference herein in their entireties.

### BACKGROUND

### 1. Field

Certain example embodiments relate to a method of generating a screenshot and/or an electronic device for performing the method.

### 2. Description of Related Art

In a mobile environment, a screenshot may be an image file which may be generated by capturing a screen output on a display by using an electronic device. The generated screenshot may be used for storing and sharing information.

### SUMMARY

According to an example embodiment, there may be provided a method of generating a screenshot and an electronic device performing the method that may utilize a screenshot in an application and/or may share the screenshot with an external electronic device by capturing the screenshot and generating metadata associated with the screenshot.

According to an example embodiment, there may be provided a method of generating a screenshot and an electronic device performing the method that may generate a screenshot and metadata, which is additional information associated with the screenshot, to improve user’s convenience by using the metadata with the screenshot are provided.

According to an example embodiment, a method of generating a screenshot and an electronic device performing the method that may access a use state at which a screenshot is captured, based on a path to output a screen of a web browser or an application when the screenshot is captured by using metadata generated with the screenshot may be provided.

According to an example embodiment, an electronic device includes a display module including at least one display, at least one processor, and a memory electrically connected, directly or indirectly, to the at least one processor and configured to store instructions executable by the at least one processor, wherein the at least one processor is configured to, when the instructions are executed, generate a screenshot by capturing a screen output on the display module, determine metadata associated with the screenshot, and store the screenshot and the metadata in the memory, wherein the metadata includes a path configured to output the screen when the screenshot is captured.

According to an example embodiment, an electronic device includes a display module, a processor, and a memory electrically connected, directly or indirectly, to the processor and configured to store instructions, a first application, and a second application that are executable by the processor, wherein the processor is configured to, when the instructions are executed, generate a screenshot by capturing a screen output on the display module by the first application, determine metadata associated with the screenshot based on an execution state of the first application, transmit the screenshot and the metadata to the second application based on an input received from a user, and control the second application by using the screenshot and the metadata, wherein the metadata includes a path configured to output the screen when the screenshot is captured.

According to an example embodiment, a method of generating a screenshot includes generating a screenshot by capturing a screen output on a display module, determining metadata associated with the screenshot, and storing the screenshot and the metadata in a memory, wherein the metadata comprises a path configured to output the screen when the screenshot is captured.

According to an example embodiment, a method of generating a screenshot and an electronic device for performing the method may reproduce a use state at which a screenshot is captured by using metadata, may fill an input item of an application utilizing a screenshot by using metadata, and may improve user’s convenience by sharing metadata with a screenshot, such as when a user views a screen after capturing a screenshot, utilizes a screenshot using an application, and/or shares a screenshot.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an example embodiment;

FIG. 2 is a block diagram illustrating a program according to an example embodiment;

FIG. 3 is a diagram illustrating an operation of an electronic device to generate a screenshot and metadata according to an example embodiment;

FIGS. 4A-4C are diagrams illustrating a screenshot and metadata generated by an electronic device according to an example embodiment;

FIG. 5 is a diagram illustrating an operation of an electronic device to generate a screenshot and metadata according to an example embodiment;

FIG. 6 is a diagram illustrating an operation of an electronic device to generate a screenshot and metadata and use and share the generated screenshot and the generated metadata, according to an example embodiment;

FIGS. 7 and 8 are diagrams illustrating an electronic device that controls a reminder application according to an example embodiment;

FIG. 8 is a diagram illustrating an operation of an electronic device to fill an input item of the reminder application by using a screenshot and metadata according to an example embodiment;

FIGS. 9 and 10 are diagrams illustrating an operation of an electronic device to capture a chat application currently running and control the reminder application according to an example embodiment;

FIGS. 11 and 12 are diagrams illustrating an operation of an electronic device to capture a map application currently running and control the reminder application according to an example embodiment; and

FIG. 13 is a diagram illustrating an operation of an electronic device to fill an input item of an email application by using a screenshot and metadata according to an example embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

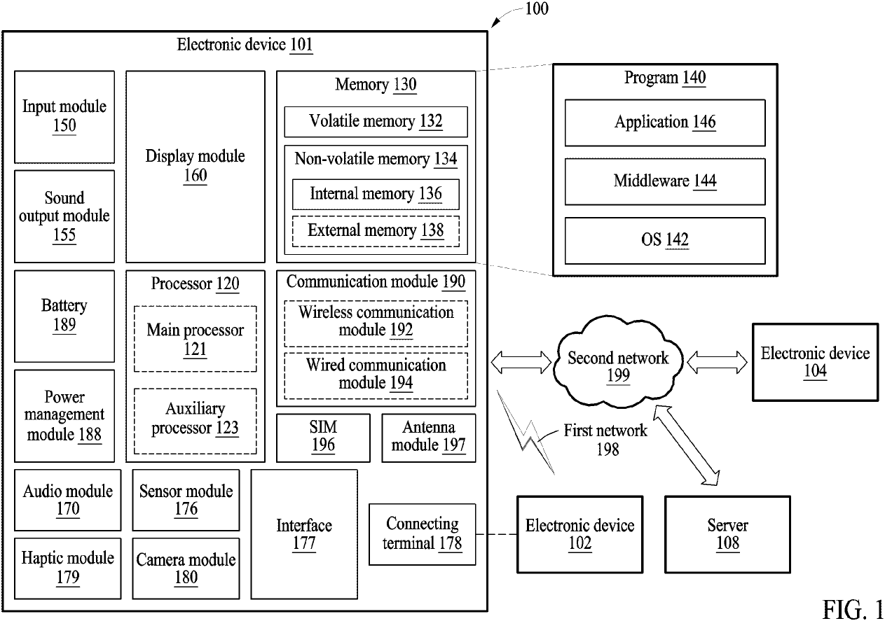

FIG. 1 is a block diagram illustrating an electronic device 101 in a network environment 100 according to various example embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor module 176, the camera module 180, or the antenna module 197) of the components may be integrated as a single component (e.g., the display module 160).

The at least one processor 120 may execute, for example, software (e.g., a program 140) to control at least one other component (e.g., a hardware or software component) of the electronic device 101 connected, directly or indirectly, to the at least one processor 120, and may perform various data processing or computation. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence (AI) model processing. An AI model may be generated through machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 comprising at least one display may visually provide information to the outside (e.g., a user) of the electronic device 101. The display module 160 may include, for example, a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electrical signal or vice versa. According to an example embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176, comprising at least one sensor, may detect an operational state (e.g., power or temperature) of the electronic device 101 or an environmental state (e.g., a state of a user) external to the electronic device 101, and generate an electric signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected, directly or indirectly, to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to an example embodiment, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an example embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

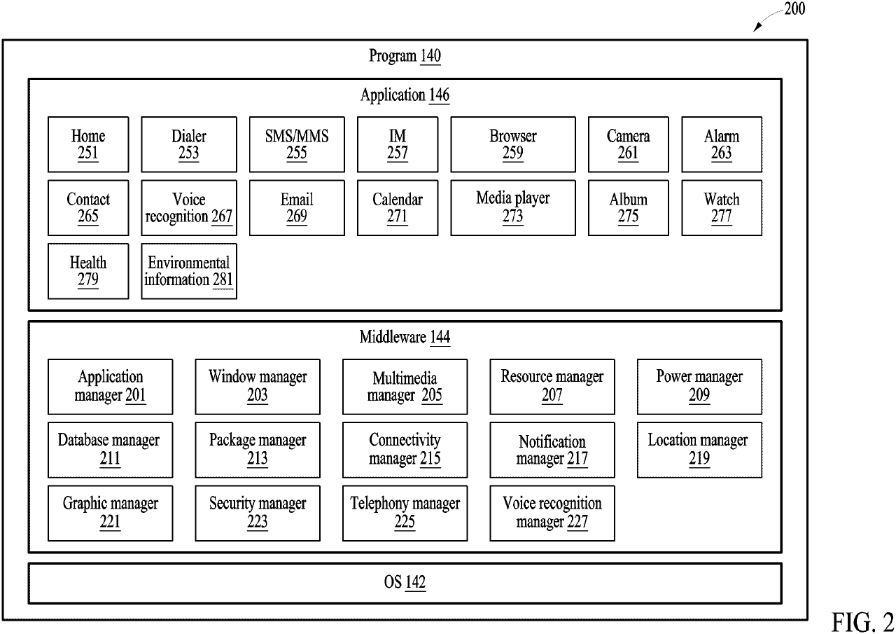

FIG. 2 is a block diagram 200 illustrating a program 140 according to an example embodiment. According to an example embodiment, the program 140 may include an OS 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocation or deallocation) of one or more system resources (e.g., a process, a memory, or a power source) of the electronic device 101. The OS 142 may additionally or alternatively include at least one other drive program to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the SIM 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201 may, for example, manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and may determine or provide related information to be used for the operation of the electronic device 101 based on at least in part on corresponding information of the capacity, temperature, or power of the battery 189. According to an example embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, a message, or an alert). The location manager 219, for example, may manage location information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit user’s voice data to the server 108, and may receive, from the server 108, a command corresponding to a function to be executed on the electronic device 101 based on at least in part on the voice data, or text data converted based on at least in part on the voice data. According to an example embodiment, the middleware 144 may dynamically delete some existing components or add new components. According to an example embodiment, at least part of the middleware 144 may be included as part of the OS 142 or may be implemented as another software separate from the OS 142. “Based on” as used herein covers based at least on.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an example embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control a power source (e.g., turning on or off) or a function (e.g., brightness, resolution, or focus) of an external electronic device that communicates with the electronic device 101 or a portion of components of the external electronic device (e.g., a display module or a camera module). The device management application may additionally or alternatively support installation, deletion, or update of an application that operates in an external electronic device.

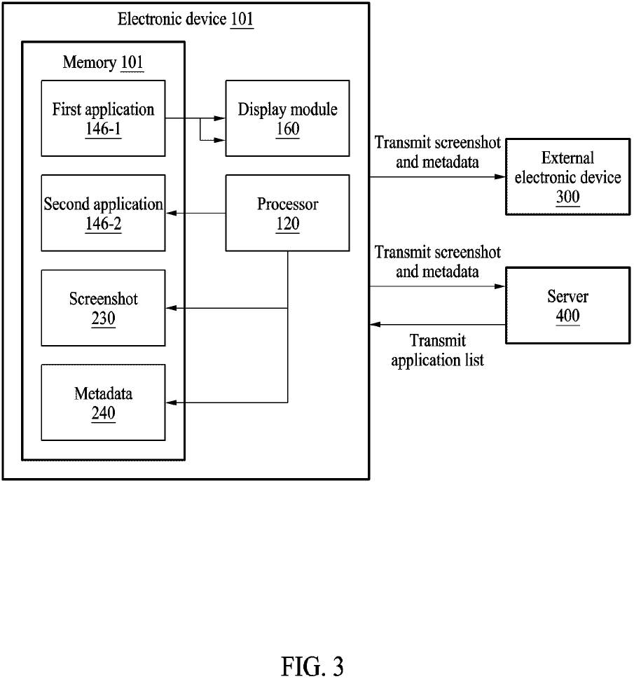

FIG. 3 is a diagram illustrating an operation of an electronic device (e.g., the electronic device 101 of FIG. 1) to generate a screenshot 230 and metadata 240 according to an example embodiment.

Referring to FIG. 3, the electronic device 101 according to an example embodiment may include a memory (e.g., the memory 130 of FIG. 1), a display module (e.g., the display module 160 of FIG. 1), and a processor (e.g., the processor 120 of FIG. 1). For example, the processor 120 of the electronic device 101 may generate the screenshot 230 by capturing a screen output to the display module 160. The generated screenshot 230 may be stored in the memory 130. For example, the processor 120 of the electronic device 101 may determine the metadata 240 associated with the screenshot 230 and store the metadata 240 in the memory 130.

In an example embodiment, the screenshot 230 generated by the processor 120 may be a screen output to the display module 160 based on a first application 146-1 (e.g., the application 146 of FIG. 2) that is currently running. The screen output to the display module 160 based on the first application 146-1 may include a GUI, an image, a moving image, and text provided by the first application 146-1.

In an example embodiment, the processor 120 may transmit the screenshot 230 and the metadata 240 to a second application 146-2 (e.g., the application 146 of FIG. 2). In an example embodiment, the processor 120 may control the second application 146-2 using the screenshot 230 and the metadata 240. For example, the processor 120 may may fill at least one input item of the second application 146-2 using the screenshot 230 and/or the metadata 240. For example, the processor 120 may control the second application 146-2 to attach the screenshot 230 to at least one of the input items of the second application 146-2.

For example, the processor 120 may control the second application 146-2 to edit the screenshot 230 using the metadata 240. By using the metadata 240, the processor 120 may edit the screenshot 230 using a path, a capture location, a capture time, device information, and a tag, which are included in the metadata 240. For example, the processor 120??? may overlay at least one of text information included in the metadata 240 on the screenshot 230.

In an example embodiment, the electronic device 101 may transmit the screenshot 230 and the metadata 240 to an external electronic device 300 (e.g., the electronic devices 102 and 104 of FIG. 1). The external electronic device 300 may use the screenshot 230 and the metadata 240 in substantially the same way that the electronic device 101 uses the screenshot 230 and the metadata 240.

For example, by using the screenshot 230 and the metadata 240, the external electronic device 300 may access a use state when the screenshot 230 is captured by the electronic device 101. For example, the external electronic device 300 may control the application 146 included in the external electronic device 300 using the screenshot 230 and the metadata 240.

For example, the electronic device 101 may transmit the screenshot 230 and the metadata 240 to a server 400 (e.g., the server 108 of FIG. 1). In response to the transmitted screenshot 230 and the metadata 240, the electronic device 101 may receive an application list from the server 400. For example, the server 400 may include a trained recommendation model. The recommendation model of the server 400 may output the application list using the input screenshot 230 and the metadata 240. For example, the application list may refer to a list of applications 146 using the screenshot 230 and the metadata 240.

The electronic device 101 may increase utilization of the screenshot 230 and/or the metadata 240 by receiving a list of applications 146 that may appropriately utilize the screenshot 230 and/or the metadata 240 from the trained recommendation model.

For example, the recommendation model may be trained using training data and target data. For example, the training data may include the screenshot 230 and/or the metadata 240. For example, the target data may include the application 146 used by users by using the screenshot 230 and/or the metadata 240.

For example, the server 400 may collect the training data and the target data from a plurality of electronic devices 101. For example, the server 400 may receive the generated screenshot 230 and the metadata 240 from the electronic devices 101 and may receive the list of applications 146 using the generated screenshot 230 and the metadata 240. The server 400 may train recommendation data by using the received generated screenshot 230 and the metadata 240 as the training data and using the list of applications 146 using the generated screenshot 230 and the metadata 240 as the target data. For example, a recommendation model training device that is distinguished from the server 400 may train the recommendation model by using training data and target data collected by the server 400.

For example, the metadata 240 included in the training data may include the application 146 (e.g., the first application 146-1 of FIG. 3) running when the screenshot 230 is generated, a user interface (UI) on which the application 146 is running when the screenshot 230 is generated outputs to the display module 160, an image, a moving image, text, a path to access an execution state when the screenshot 230 is captured, a capture time, a capture location, a model name of the electronic device 101 that generates the screenshot 230, device information, such as an OS version, tag information, and connected device information. The application 146 running when the screenshot 230 is generated may be one or a plurality of applications 146 configured to output a UI, an image, a moving image, and text to the display module 160 when the screenshot 230 is generated.

For example, the electronic device 101 may determine the application 146 configured to output at least one of a UI, an image, a moving image, and text to the display module 160 by using the life cycle of the application 146. For example, in a mode (e.g., a multi-window mode) in which two or more applications 146 simultaneously output at least one of a UI, an image, a moving image, and text to the display module 160, the electronic device 101 may include the two or more applications 146 in the metadata 240 For example, the electronic device 101 may manage the life cycle of the application 146 by using an application manager (e.g., the application manager 201 of FIG. 2).

As described above, the metadata 240 included in the training data for training the recommendation model may include a situation when a user generates the screenshot 230 using the electronic device 101, a purpose of use of the screenshot 230, and information provided to the user by the application 146 running when the screenshot 230 is generated. The recommendation model may be trained using the training data including the metadata 240 and may output an application list appropriate to use the screenshot 230 and/or the metadata 240 generated by the user.

In an example embodiment, the electronic device 101 may transmit the screenshot 230, the metadata 240, and the application 146 to the server 400. In response to the transmitted screenshot 230, the metadata 240, and the application 146, the electronic device 101 may receive an application control signal from the server 400. The application 146 transmitted to the server 400 by the electronic device 101 may refer to the application 146 selected by the user to use the screenshot 230 and/or the metadata 240.

The electronic device 101 may input the screenshot 230 and the metadata 240 to at least one input item of the application 146 by using the received application control signal. The electronic device 101 may input the screenshot 230 and/or the metadata 240 to the input item of the application 146 by using a trained editing model. The electronic device 101 may increase utilization of the screenshot 230 and/or the metadata 240 by providing an appropriate input to the input item of the application 146 by using the trained editing model.

In an example embodiment, the server 400 may include an editing model. In an example embodiment, the server 400 may train the editing model by using the screenshot 230, the metadata 240, and the application 146 as training data and using the screenshot 230 and/or the metadata 240 that is input to the input item of the application 146 as target data.

For example, training of the editing model may be performed in substantially the same way as training of the recommendation model. For example, the server 400 may receive, from the electronic device 101, the generated screenshot 230, the metadata 240, the application 146, and the screenshot 230 and/or the metadata 240, which are input to the input item of the application 146. The server 400 or an editing model training device may train the editing model by using the training data and the target data received by the server 400.

In the above description, the server 400 including the trained recommendation model and the editing model is only an example of various embodiments and not limited thereto. For example, the electronic device 101 may include the trained recommendation model and/or the editing model. The electronic device 101 may output an application list and/or an application control signal by using the recommendation model and/or the editing model included in the electronic device 101.

In an example embodiment, various well-known neural network models may apply to the recommendation model and the training model. For example, a neural network model may include a plurality of artificial neural network layers. An artificial neural network may include one of a DNN, a CNN, an RNN, an RBM, a DBN, a BRDNN, and a deep Q-network, but examples are not limited thereto. The neural network model may additionally or alternatively include a software structure other than a hardware structure.

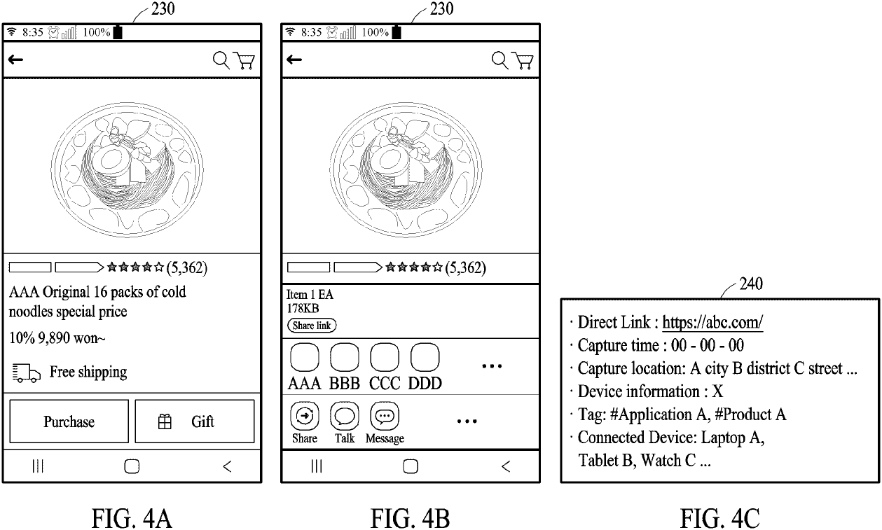

FIGS. 4A to 4C are diagrams illustrating a screenshot (e.g., the screenshot 230 of FIG. 3) and metadata (e.g., the metadata 240 of FIG. 3) generated by an electronic device (e.g., the electronic device 101 of FIG. 1) according to an example embodiment.

Referring to FIG. 4A, the electronic device 101 according to an example embodiment may generate the screenshot 230. As illustrated in FIG. 4A, a screen output on a display module (e.g., the display module 160 of FIG. 1) may include a UI, an image, a moving image, and text output on the display module 160 by an application (e.g., the application 146 of FIG. 2) or a browser (e.g., the browser 259 of FIG. 2) that is run when the screenshot 230 is generated. For example, the electronic device 101 may generate the screenshot 230 based on the screen output on the display module 160. The electronic device 101 may generate the screenshot 230 in an image file format and may store the generated screenshot 230 in a memory (e.g., the memory 130 of FIG. 1).

FIG. 4B is a diagram illustrating an application list provided by the electronic device 101 according to an example embodiment. In an example embodiment, the application list may be about an the application 146 associated with the generated screenshot 230. The application list may refer to applications 146 that may use the generated screenshot 230 and/or the metadata 240. For example, in FIG. 4B, when the electronic device 101 receives an input from the user to select one from the application list by a user, the electronic device 101 may transmit the generated screenshot 230 and/or metadata 240 to the selected application 146.

For example, referring to FIG. 4B, the electronic device 101 according to an example embodiment may provide an application list that is output by using a trained application 146 recommendation model based on the metadata 240.

FIG. 4C is a diagram illustrating the metadata 240 generated by the electronic device 101 according to an example embodiment. For example, the electronic device 101 may determine the metadata 240 when generating the screenshot 230.

For example, the electronic device 101 may determine the metadata 240 based on a time when the screenshot 230 is generated, a location of the electronic device 101, information of a device, the application 146 currently running, and the external electronic device 300 connected, directly or indirectly, to the electronic device 101.

For example, the processor 120 of the electronic device 101 may determine the metadata 240 by using information processed by the application 146 that is currently running. For example, the information processed by the application 146 may include a UI, an image, a moving image, and text, which are processed and provided by the application 146. For example, the information processed by the application 146 illustrated in the screenshot 230 of FIG. 4A may include an image, a UI, and text.

Referring to FIG. 4C, the metadata 240 may include a path. For example, the path may refer to an access path to output a screen when the screenshot 230 is captured. For example, when a user accesses the captured screenshot 230, the electronic device 101 may access a use state when the screenshot 230 is captured by using the path. For example, accessing the use state when the screenshot 230 is captured may refer to reproducing a use state of the application 146, the browser 259, and the like when the screenshot 230 is captured.

For example, while the browser 259 is executed and a web page A opens, the electronic device 101 may capture the screenshot 230. When the electronic device 101 receives an input to select the path in the captured screenshot 230 from the user, the electronic device 101 may execute the browser 259, may access the web page A, and may output the web page A on the display module 160.

For example, the electronic device 101 may capture the screenshot 230 while an application A is executed. When the electronic device 101 receives an input to select a path in the captured screenshot 230 from the user, the electronic device 101 may execute the application A and may output, on the display module 160, an execution state of the application A when the screenshot 230 is captured.

For example, accessing the use state when the screenshot 230 is captured may refer to reproducing a use state of the application 146. For example, while a contact application 146 is executed, the electronic device 101 may capture a stored contact address of person A as the screenshot 230. When the electronic device 101 receives an input to select a path in the screenshot 230 from the user, the electronic device 101 may execute the contact application 146 and may output the contact address of person A on the display module 160.

For example, when the electronic device 101 receives an input to select “http://abc.com/” displayed as “Direct link” included in the metadata 240 of FIG. 4C, the electronic device 101 may execute the web browser 259 and may access the displayed address “http://abc.com/”. For example, the displayed address “http://abc.com/” may be a web page address of FIGS. 4A or 4B.

In an example embodiment, the electronic device 101 may store information of the application 146 that is run when the screenshot 230 is captured. For example, an access path (e″g., “Direct″Link” of FIG. 4C) included in the metadata 240 generated by the electronic device 101 may include information of the application 146 that is run.

As shown in FIG. 4C, the electronic device 101 may determine a tag using the screenshot 230. For example, referring to FIG. 4C, the electronic device 101 may include a product A as a tag by using an application A that is executed when the screenshot 230 is captured, an image, text, and a moving image that are included in the screenshot 230.

In an example embodiment, the electronic device 101 may transmit the screenshot 230 and the metadata 240 to the external electronic device 300. The external electronic device 300 may access a state at which the screenshot 230 is captured by the electronic device 101 by using a path included in the metadata 240.

For example, while the application A is executed as illustrated in FIG. 4A, the electronic device 101 may capture the screenshot 230 and may transmit the generated screenshot 230 and the metadata 240 to the external electronic device 300. By using the path in the received metadata 240 as shown in FIG. 4C, the external electronic device 300 may access the state shown in FIG. 4A. For example, when the external electronic device 300 receives an input to select a path from the user, the external electronic device (e.g., the external electronic device 300 of FIG. 3) may execute the application A, may access a page shown in FIG. 4A, and may reproduce an execution state at which the screenshot 230 is captured by the electronic device 101.

In an example embodiment, the metadata 240 determined by the electronic device 101 may include device information. For example, the device information may include a model, a type, a form factor, an OS type, or a version of the electronic device 101.

In an example embodiment, the electronic device 101 may determine the metadata 240 based on at least one of the application 146 that is executed when the screenshot 230 is captured or an object included in the screenshot 230.

For example, the electronic device 101 may determine the metadata 240 based on the application 146 that is executed when the screenshot 230 is captured. For example, when the application 146 that is executed is “Game A”, the electronic device 101 may determine the metadata 240 including a link address of the official website of “Game A” and a link address of a website related to “Game A”, such as a link address of a walkthrough website of “Game A”.

For example, the electronic device 101 may determine the metadata 240 based on an object included in the screenshot 230. The electronic device 101 may identify an object included in the screenshot 230. For example, the electronic device 101 may identify an object through an image analysis of the screenshot 230. For example, the electronic device 101 may identify an object included in the screenshot 230 by using information of the application 146 that is executed when the screenshot 230 is captured, tag information, and text information processed by the application 146.

For example, when an object included in the screenshot 230 is food, the electronic device 101 may determine the metadata 240 by a link address of a search result of recipes of the food, a link address of a search result of recipes of the food in a website on cooking methods, a link address of a food sales website, a link address of a search result of information on a dish (e.g., a link address of a website that sells the main ingredients of the dish and a link address of a search result of a method of preparing the dish with the main ingredients).

For example, when the object included in the screenshot 230 is accommodations, the electronic device 101 may determine a link address related to the accommodations to be the metadata. For example, the link address related to the accommodations may be a link address related to the accommodations or the location of the accommodations, such as a link address of a website of the accommodations, a link address of a website of another accommodation adjacent to the accommodations, a link address of a search result of a tourist spot or a famous restaurant near the accommodations.

For example, when the object included in the screenshot 230 is a product, the electronic device 101 may determine a link address related to the product to be the metadata. For example, when the object included in the screenshot 230 is a home appliance, the electronic device 101 may determine a link address related to the home appliance to be the metadata 240. The link address related to the home appliance may be a link address of a website of a manufacturer or a distributer of the home appliance and a link address of a website that sells the home appliance.

In an example embodiment, when the electronic device 101 transmits the screenshot 230 to the external electronic device 300, the electronic device 101 may transmit the metadata 240 to the external electronic device 300. For example, the electronic device 101 may transmit an access path or a link address included in the metadata 240 to the external electronic device 300

In an example embodiment, the electronic device 101 may transmit at least one of items included in the metadata 240 as text to the external electronic device 300. The electronic device 101 may transmit the screenshot 230 via a chat application or may transmit the screenshot 230 via a messenger application (e.g., the SMS/MMS application 255 of FIG. 2) to the external electronic device 300. With the screenshot 230, the electronic device 101 may transmit at least one of items included in the metadata 240 as text to the external electronic device 300.

For example, the electronic device 101 may transmit, to the external electronic device 300?????, the metadata 240 determined based on the application 146 that is executed when the screenshot 230 is captured or an object included in the screenshot 230.

For example, the electronic device 101 may transmit an access path of the metadata 240 to the external electronic device 300.

For example, when transmitting, to the external electronic device 300, the screenshot 230 captured when the application 146, that is, “Game A”, is executed, the electronic device 101 may transmit a link address of the official website of “Game A” to the external electronic device 300.

For example, the electronic device 101 may combine the metadata 240 with the screenshot 230. In an example embodiment, the electronic device 101 may transmit the screenshot 230 combined with the metadata 240 to the external electronic device 300.

For example, the electronic device 101 may display an input item that allows to select an access path or a link address included in the metadata 240 on an image of the screenshot 230.

For example, when the electronic device 101 or the external electronic device 300 that received the screenshot 230 receives an input to select the access path displayed on the screenshot 230, the electronic device 101 or the external electronic device 300 may access a use state at which the screenshot 230 is captured.

For example, when the electronic device 101 or the external electronic device 300 that received the screenshot 230 selects the link address displayed on the screenshot 230, the electronic device 101 or the external electronic device 300 may access the link address included in the metadata 240. As described above, the link address may refer to the link address of the official website of “Game A”, the link address of the website related to the food, and the like.

The above description of the metadata 240 is an example, and the electronic device 101 may determine the metadata 240 without being limited to the above example. For example, the electronic device 101 may determine the metadata 240 based on a user’s input. For example, when capturing the screenshot 230, the electronic device 101 may determine the metadata 240 by a link address or tag information input by the user.

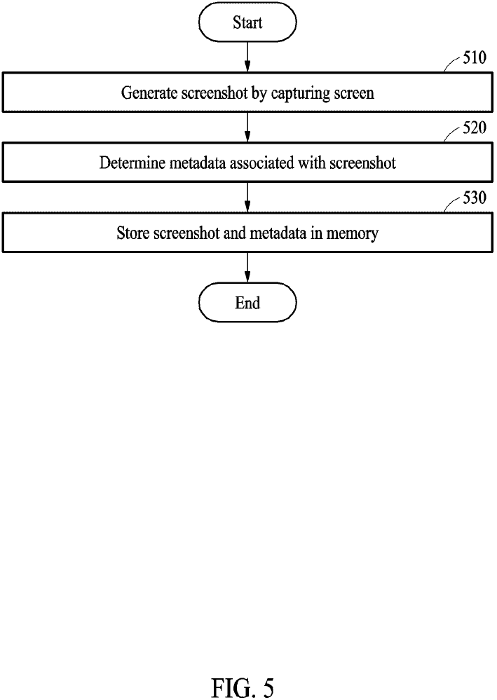

FIG. 5 is a diagram illustrating an operation of an electronic device (e.g., the electronic device 101 of FIG. 1) to generate a screenshot (e.g., the screenshot 230 of FIG. 3) and metadata (e.g., the metadata 240 of FIG. 3) according to an example embodiment.

In operation 510, the electronic device 101 according to an example embodiment may generate the screenshot 230 by capturing a screen output on a display module (e.g., the display module 160 of FIG. 1). For example, the electronic device 101 may capture a screen that a currently running process, such as an application (e.g., the application 146), an OS, a web browser (e.g., the browser 259 of FIG. 2), outputs on the display module 160. For example, the electronic device 101 may generate the screenshot 230 by receiving an input to capture a screen from a user.

In operation 520, the electronic device 101 may determine the metadata 240 associated with the screenshot 230. For example, the electronic device 101 may determine the metadata 240 including a path, a capture time, a capture location, device information, a tag, and connected device information. For example, the electronic device 101 may determine the metadata 240 by using information processed by a currently running process, such as the application 146 that is executed when the screenshot 230 is captured, the browser 259, and the OS. For example, the information processed by a currently running process may include a UI, an image, a moving image, and text output on the display module 160. The electronic device 101 may determine the metadata 240 using a UI, an image, a moving image, and text that are not output on the display module 160.

In operation 530, the electronic device 101 may store the screenshot 230 and the metadata 240 in the memory 130. The electronic device 101 may transmit the screenshot 230 and the metadata 240 stored in the memory 130 to a server (e.g., the server 400 of FIG. 3), an external electronic device (e.g., the external electronic device 300 of FIG. 3), and the application 146 of the electronic device 101.

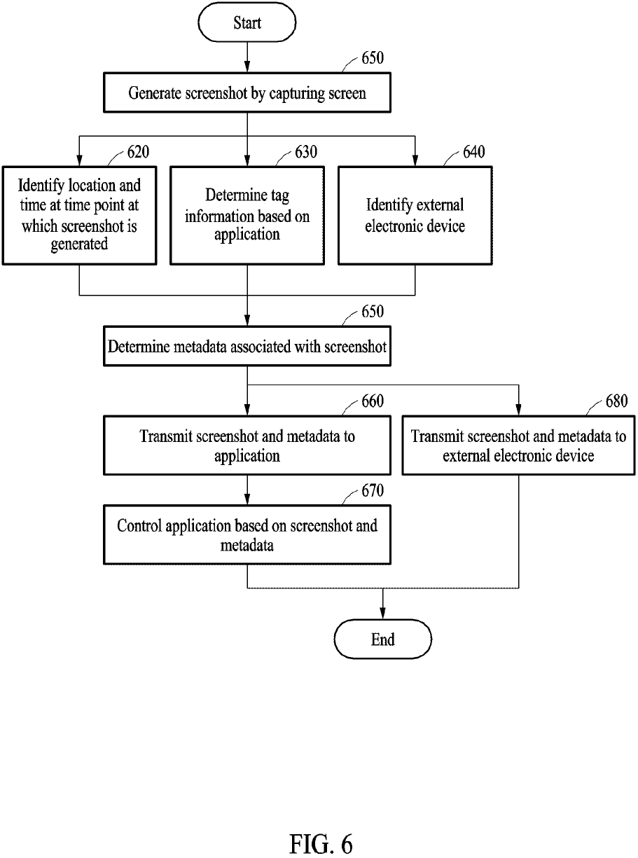

FIG. 6 is a diagram illustrating an operation of an electronic device (e.g., the electronic device 101 of FIG. 1) to generate a screenshot (e.g., the screenshot 230 of FIG. 3) and metadata (e.g., the metadata 240 of FIG. 3) and use and share the generated screenshot 230 and the generated metadata 240, according to an example embodiment.

Referring to FIG. 6, in operation 610, the electronic device 101 may generate the screenshot 230 by capturing a screen. The description of operation 510 of FIG. 5 may apply to operation 610 substantially in the same manner.

In operation 620, the electronic device 101 may identify a location and a time at which the screenshot 230 is generated. For example, the electronic device 101 may identify the location of the electronic device 101 by using a global positioning system (GPS).

In operation 630, the electronic device 101 may determine tag information based on an application (e.g., the application 146 of FIG. 2). For example, the electronic device 101 may determine tag information by using a UI, an image, a moving image, and text associated with the application 146 that is executed when the screenshot 230 is captured. Unlike the example illustrated in FIG. 6, the electronic device 101 may determine the tag information based on the browser 259 that is executed when the screenshot 230 is captured and an OS (e.g., the OS 142 of FIG. 1).

In operation 640, the electronic device 101 may identify the external electronic device 300. For example, the electronic device 101 may identify the external electronic device 300 connected by wires or wirelessly to the electronic device 101 through a communication module (e.g., the communication module 190 of FIG. 1, comprising communication circuitry).

In operation 650, the electronic device 101 may determine the metadata 240 associated with the screenshot 230. For example, the electronic device 101 may determine the metadata 240 including a capture location, a capture time, a tag, and the connected external electronic device 300.

In operation 660, the electronic device 101 may transmit the screenshot 230 and the metadata 240 to the application 146. In operation 660, the application 146 receiving the screenshot 230 and the metadata 240 may be the application 146 for utilizing the screenshot 230 and the metadata 240 based on an input received from the user.

In operation 670, the electronic device 101 may control the application 146 based on the screenshot 230 and the metadata 240. For example, the electronic device 101 may determine at least one of input items of the application 146, based on the screenshot 230 and the metadata 240. For example, the electronic device 101 may attach the screenshot 230 to the input item of the application 146.

In operation 680, the electronic device 101 may transmit the screenshot 230 and the metadata 240 to an external electronic device (e.g., the external electronic device 300 of FIG. 3). For example, the electronic device 101 may transmit, to the external electronic device 300, user information signed in the electronic device 101 and the associated metadata 240, based on user information signed in the external electronic device 300.

For example, when the user information signed in the external electronic device 300 is the same as the user information signed in the electronic device 101, the electronic device 101 may transmit the metadata 240 associated with the user information to the external electronic device 300. For example, when the user information signed in the external electronic device 300 is different from the user information signed in the electronic device 101, the electronic device 101 may transmit the metadata 240 excluding the metadata 240 associated with the user information to the external electronic device 300.

For example, the metadata 240 associated with the user information may refer to data on private information of the user, such as a capture location, a capture time, device information, and the connected external electronic device 300.

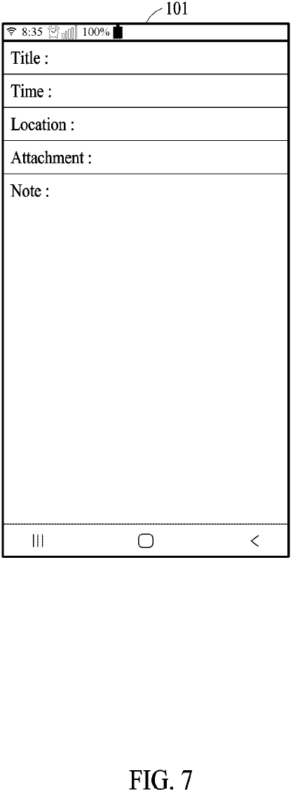

Hereinafter, FIGS. 7 to 13 are diagrams illustrating a screen output on the display module 160 of the electronic device 101 and may represent the captured screenshot 230 or the currently running application 146.

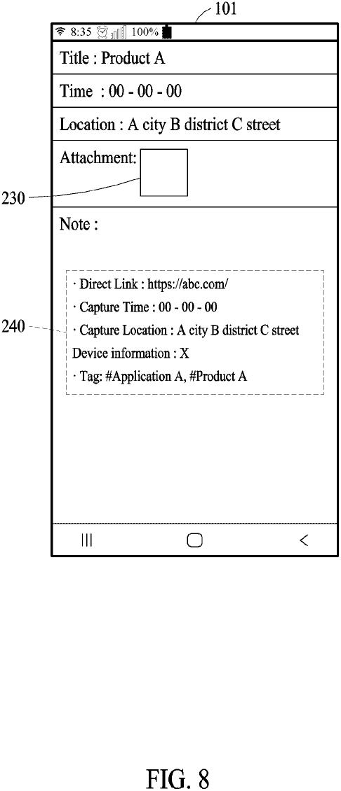

FIGS. 7 and 8 are diagrams illustrating an electronic device (e.g., the electronic device 101 of FIG. 1) that controls a reminder application (e.g., the application 146 of FIG. 2) according to an example embodiment. FIG. 8 illustrates an operation of the electronic device to control the reminder application 146 using a screenshot (e.g., the screenshot 230 of FIG. 3) and metadata (e.g., the metadata 240 of FIG. 3) illustrated in FIG. 4.

As illustrated in FIG. 7, the reminder application 146 according to an example embodiment may include an input item, such as a title, a time, a location, an attachment, and a note. For example, the reminder application 146 may be understood as an application that notifies a user at a set time.

Referring to FIG. 8, the electronic device 101 according to an example embodiment may control the application 146, based on the screenshot 230 and the metadata 240. In an example embodiment, the electronic device 101 may attach the screenshot 230 to at least one of the input items of the application 146. In an example embodiment, the electronic device 101 may input the metadata 240 to at least one of the input items of the application 146.

For example, as shown in FIG. 8, the electronic device 101 may fill at least one of the input items of the application 146, based on the screenshot 230 and the metadata 240. For example, the electronic device 101 may fill a title, a time, a location, an attachment, and a note, which are the input items of the reminder application 146, by using the screenshot 230 and the metadata 240.

For example, the electronic device 101 may input the screenshot 230 and the metadata 240 to at least one of the input items of the application 146 by using a trained editing model. For example, the electronic device 101 may output an application control signal by inputting the screenshot 230 and the metadata 240 to the trained editing model. As shown in FIG. 8, the electronic device 101 may attach or input the screenshot 230 and/or the metadata 240 to the input item of the application 146 by using the application control signal.

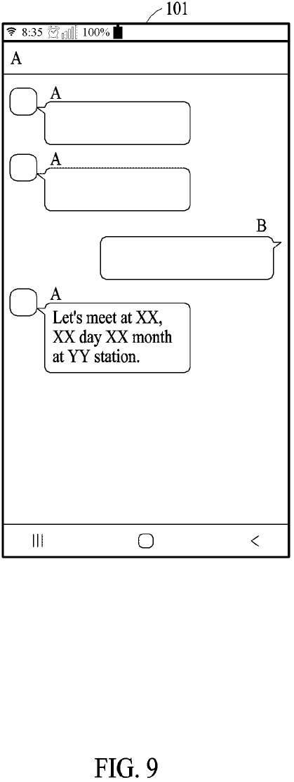

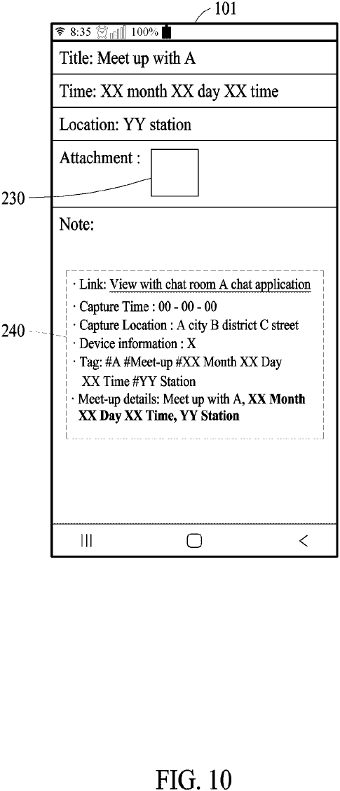

FIGS. 9 and 10 are diagrams illustrating an operation of an electronic device (e.g., the electronic device 101 of FIG. 1) to capture a chat application (e.g., the application 146 of FIG. 2) that is currently running and control a reminder application (e.g., the application 146 of FIG. 2) according to an example embodiment.

In an example embodiment, the electronic device 101 may determine the metadata 240 based on the application 146. For example, the electronic device 101 may determine metadata (e.g., the metadata 240 of FIG. 3) by using a UI, an image, a moving image, and text of the application 146 that is executed when a screenshot (e.g., the screenshot 230 of FIG. 3) is captured.

For example, as shown in FIGS. 9 and 10, the electronic device 101 may determine the metadata 240 by using text provided by the chat application 146 currently running. For example, the electronic device 101 may determine the metadata 240, “Meet-up details: Meet with A, XX month XX day XX time at YY station” by using text that is processed by the chat application 146 and output to the display module 160. The electronic device 101 may attach the screenshot 230 to the attachment item of the reminder application 146.

In an example embodiment, as shown in FIG. 10, the electronic device 101 may fill a title, a time, a location, which are input items of the reminder application 146, based on text processed by the chat application 146. The electronic device 101 may input “Meet with A”, “XX month XX day XX time”, “YY station” to the title, the time, and the location, respectively, based on the metadata 240.

In an example embodiment, the electronic device 101 may include a natural language understanding (NLU) module configured to understand an intent of text. For example, the electronic device 101 may identify an intent of the text received from the application 146 by using the NLU module. For example, the NLU module may discern the intent of the text by performing syntactic analysis or semantic analysis. The NLU module may discern the meaning of a word included in the text using a linguistic feature (e.g., a grammatical element) of a morpheme or phrase and may determine the intent of the text by matching the discerned meaning of the word to an intent.

For example, the electronic device 101 may receive text included in the screenshot 230 of FIG. 9 from the application 146. The electronic device 101 may discern the intent of the received text using the NLU module. For example, the electronic device 101 may discern the intent of proposing a meet-up time and location from the text included in the screenshot 230 of FIG. 9 by using the NLU module.

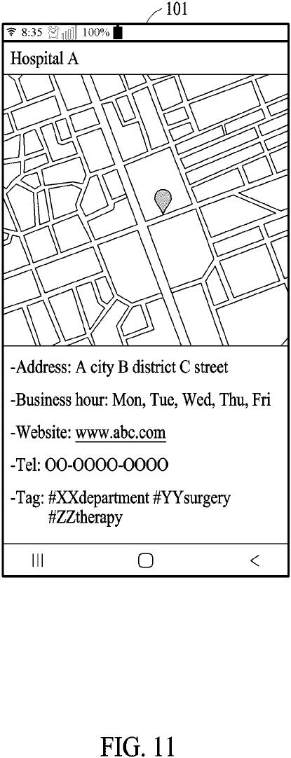

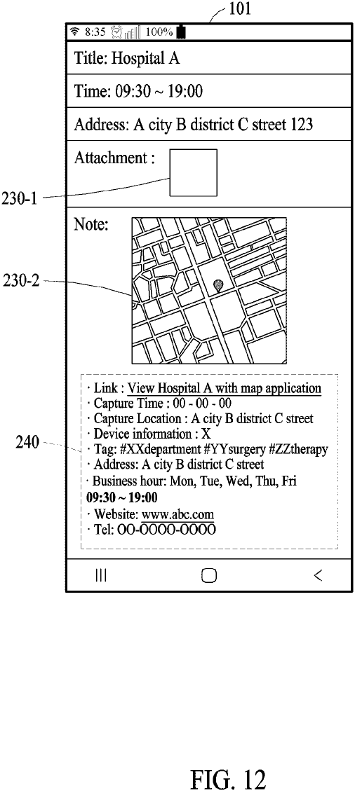

FIGS. 11 and 12 are diagrams illustrating an operation of an electronic device (e.g., the electronic device 101 of FIG. 1) to capture a map application (e.g. the application 146 of FIG. 2) currently running and control a reminder application (e.g., the application 146 of FIG. 2) according to an example embodiment.

As illustrated in FIG. 11, when a screenshot (e.g., the screenshot 230 of FIG. 3) is captured while the map application 146 is running, as illustrated in FIG. 12, the electronic device 101 may control the reminder application 146 by using the generated screenshot 230 and metadata (e.g., the metadata 240 of FIG. 3).

In an example embodiment, as illustrated in FIG. 12, the electronic device 101 may fill a title, a time, a location, and a note of input items of the reminder application 146 by using an image of the map application 146 and/or the metadata 240 determined based on text information. The electronic device 101 may input the generated screenshot 230 to the attachment item.

Referring to FIG. 12, when the electronic device 101 receives an input to select a path of the metadata 240, “See Hospital A in the map application 146”, the electronic device 101 may execute the map application 146 and may output a screen illustrated in FIG. 11, which is the screen when the screenshot 230 is captured, on the display module 160.

As illustrated in FIG. 12, the electronic device 101 may determine the metadata 240 by a tag, an address, business hours, a website, and a phone number by using text processed by the map application 146.

The electronic device 101 may input the generated screenshot 230 as illustrated in FIG. 12 as an image to the note and may attach the image file of the screenshot 230 to the attachment item.

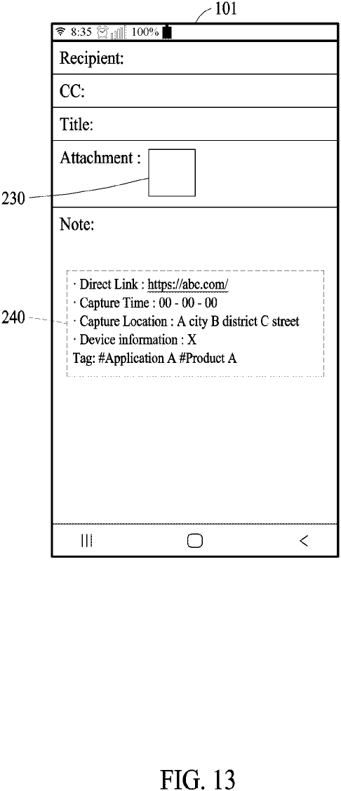

FIG. 13 is a diagram illustrating an operation of an electronic device (e.g., the electronic device 101 of FIG. 1) to fill an input item of an email application (e.g., the application 146 of FIG. 2) by using a screenshot (e.g., the screenshot 230 of FIG. 3) and metadata (e.g., the metadata 240 of FIG. 3) according to an example embodiment.

In an example embodiment, the electronic device 101 may control the email application 146 by using the generated screenshot 230 and the metadata 240 as illustrated in FIG. 13. The electronic device 101 may input the generated metadata 240 to the body of an email. In an example embodiment, the electronic device 101 may fill a title of an email by using the generated metadata 240. For example, the electronic device 101 may input “Product A” to a title of an email by using a tag of the metadata 240.

According to an example embodiment, an electronic device (e.g., the electronic device 101 of FIG. 1) may include a display module (e.g., the display module 160 of FIG. 1), a processor (e.g., the processor 120 of FIG. 1), and a memory (e.g., the memory 130 of FIG. 1) electrically connected, directly or indirectly, to the at least one processor 120 and configured to store instructions executable by the at least one processor 120, wherein the at least one processor 120 may be configured to when the instructions are executed, generate a screenshot (e.g., the screenshot 230 of FIG. 3) by capturing a screen output on the display module 160, determine metadata (e.g., the metadata 240 of FIG. 3) associated with the screenshot 230, and store the screenshot 230 and the metadata 240 in the memory 130, wherein the metadata 240 may include a path configured to output the screen when the screenshot 230 is captured.

The processor 120 may be configured to identify a location and a time of the electronic device 101 that generates the screenshot 230 at a time point at which the screenshot 230 is generated, determine tag information of the screenshot 230 based on an application (e.g., the application 146 of FIG. 2) configured to output the screen, and identify an external electronic device (e.g., the external electronic device 300 of FIG. 3) connected to the electronic device 101.

The processor 120 may be further configured to transmit the screenshot 230 and the metadata 240 to the application 146 based on an input received from a user, and control the application 146 based on the screenshot 230 and the metadata 240. Each “processor” herein comprises processing circuitry.

The processor 120 may be further configured to attach the screenshot 230 to at least one of input items of the application 146, and input the metadata 240 to at least one of the input items of the application 146.

The processor 120 may be further configured to provide an application list output by using a trained recommendation model based on the metadata 240.

The processor 120 may be further configured to input the screenshot 230 and the metadata 240 to at least one of the input items of the application 146 by using a trained editing model.

The processor 120 may be further configured to transmit the screenshot 230 and the metadata 240 to the external electronic device 300 connected to the electronic device 101 that generated the screenshot 230 based on an input received from a user.

The processor 120 may be further configured to transmit the metadata 240 related to user information signed in the electronic device 101 to the external electronic device 300 based on user information signed in the external electronic device 300.

According to an example embodiment, the electronic device 101 may include the display module 160 comprising at least one display, at least one processor 120, and the memory 130 electrically connected, directly or indirectly, to the at least one processor and configured to store instructions, the first application 146-1, and the second application 146-2 that are executable by the at least one processor, wherein the at least one processor 120 may be configured to, when the instructions are executed, generate a screenshot 230 by capturing a screen output on the display module 160 by the first application 146-1, determine metadata 240 associated with the screenshot 230 based on an execution state of the first application 146-1, transmit the screenshot 230 and the metadata 240 to the second application 146-2 based on an input received from a user, and control the second application 146-2 by using the screenshot 230 and the metadata 240, wherein the metadata 240 may include a path configured to output the screen when the screenshot 230 is captured.

The processor 120 may be further configured to identify a location and a time of the electronic device 191 that generates the screenshot 230 at a time point at which the screenshot 230 is generated, determine tag information of the screenshot 230 based on the first application 146-1, and identify the external electronic device 300 connected to the electronic device 101.

The processor 120 may be further configured to attach the screenshot 230 to at least one of input items of the second application 146-2, and input the metadata 240 to at least one of the input items of the second application 146-2.

The processor 120 may be further configured to transmit the screenshot 230 and the metadata 240 to the external electronic device 300 connected to the electronic device 101 that generated the screenshot 230 based on an input received from a user.

According to an example embodiment, a method of generating a screenshot 230, the method may include generating the screenshot 230 by capturing a screen output on the display module 160, determining metadata 240 associated with the screenshot 230, and storing the screenshot 230 and the metadata 240 in the memory 130, wherein the metadata 240 may include a path configured to output the screen when the screenshot 230 is captured.

The determining of the metadata 240 may include identifying a location and a time of the electronic device 101 that generates the screenshot 230 at a time point at which the screenshot 230 is generated, determining tag information of the screenshot 230 based on the application 146 configured to output the screen, and identifying the external electronic device 300 connected to the electronic device 101.

The method may further include transmitting the screenshot 230 and the metadata 240 to the application 146 based on an input received from a user, and controlling the application 146 based on the screenshot 230 and the metadata 240.

The controlling of the application 146 may include attaching the screenshot 230 to at least one of input items of the application 146, and inputting the metadata 240 to at least one of the input items of the application 146.

The method may further include providing an application list output by using a trained recommendation model based on the metadata 240.

The controlling of the application 146 may include inputting the screenshot 230 and the metadata 240 to at least one of input items of the application 146 by using a trained editing model.

The method may further include transmitting the screenshot 230 and the metadata 240 to the external electronic device 300 connected to the electronic device 101 that generated the screenshot 230 based on an input received from a user.

The transmitting to the external electronic device 300 may include transmitting the metadata 240 related to user information signed in the electronic device 101 to the external electronic device 300 based on user information signed in the external electronic device 300.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an example embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1st,” “2nd,” or “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via at least a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example embodiment, the module may be implemented in a form of an application-specific integrated circuit (ASIC). Thus, each “module” herein may comprise circuitry.

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer’s server, a server of the application store, or a relay server.

Each embodiment herein may be used in combination with any other embodiment(s) described herein.

According to example embodiments, each component (e.g., a module or a program) of the above-described components may include a single entity or multiple entities, and some of the multiple entities may be separately disposed in different components. According to example embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various example embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display module including at least one display;
at least one processor; and
a memory electrically connected to the at least one processor and configured to store instructions executable by the at least one processor,
wherein the at least one processor is configured to:
generate a screenshot at least by capturing a screen output via the display module,
determine metadata associated with the screenshot, and
store the screenshot and the metadata in the memory,
wherein the metadata comprises a path configured to output the screen when the screenshot is captured.

2. The electronic device of claim 1, wherein the at least one processor is further configured to:
identify a location and a time of the electronic device that generates the screenshot at a time point at which the screenshot is generated,
determine tag information of the screenshot based on an application configured to output the screen, and
identify an external electronic device connected to the electronic device.

3. The electronic device of claim 1, wherein the at least one processor is further configured to:
control to transmit the screenshot and the metadata to an application based on an input received from a user, and
control the application based on the screenshot and the metadata.

4. The electronic device of claim 3, wherein the at least one processor is further configured to:
attach the screenshot to at least one of input items of the application, and
input the metadata to at least one of the input items of the application.

5. The electronic device of claim 3, wherein the at least one processor is further configured to provide an application list output at least by using a trained recommendation model based on the metadata.

6. The electronic device of claim 3, wherein the at least one processor is further configured to input the screenshot and the metadata to at least one of the input items of the application at least by using a trained editing model.

7. The electronic device of claim 1, wherein the at least one processor is further configured to control to transmit the screenshot and the metadata to an external electronic device connected to the electronic device based on an input received from a user.

8. The electronic device of claim 7, wherein the at least one processor is further configured to control to transmit the metadata related to user information in the electronic device to the external electronic device based on user information in the external electronic device.

9. An electronic device comprising:
a display module comprising at least one display;
at least one processor; and
a memory electrically connected to the at least one processor and configured to store instructions, a first application, and a second application that are executable by the at least one processor,
wherein the at least one processor is configured to:
generate a screenshot at least by capturing a screen output via the display module by the first application,
determine metadata associated with the screenshot based on an execution state of the first application,
control to transmit the screenshot and the metadata to the second application based on an input received from a user, and
control the second application at least by using the screenshot and the metadata,
wherein the metadata comprises a path configured to output the screen.

10. The electronic device of claim 9, wherein the at least one processor is further configured to:
identify a location and a time of the electronic device that generates the screenshot at a time point at which the screenshot is generated,
determine tag information of the screenshot based on the first application, and
identify an external electronic device connected to the electronic device.

11. The electronic device of claim 9, wherein the at least one processor is further configured to:
attach the screenshot to at least one of input items of the second application, and
input the metadata to at least one of the input items of the second application.

12. The electronic device of claim 9, wherein the at least one processor is further configured to control to transmit the screenshot and the metadata to an external electronic device connected to the electronic device that generated the screenshot based on an input received from a user.

13. A method of generating a screenshot, the method comprising:
generating a screenshot by capturing a screen output via a display;
determining metadata associated with the screenshot; and
storing the screenshot and the metadata in a memory,
wherein the metadata comprises a path configured to output the screen when the screenshot is captured.

14. The method of claim 13, wherein the determining of the metadata comprises:
identifying a location and a time of an electronic device that generates the screenshot at a time point at which the screenshot is generated;
determining tag information of the screenshot based on an application configured to output the screen; and
identifying an external electronic device connected to the electronic device.

15. The method of claim 13, further comprising:
transmitting the screenshot and the metadata to an application based on an input received from a user; and
controlling the application based on the screenshot and the metadata.

16. The method of claim 15, wherein the controlling of the application comprises:
attaching the screenshot to at least one of input items of the application; and
inputting the metadata to at least one of the input items of the application.

17. The method of claim 15, further comprising:
providing an application list output at least by using a trained recommendation model based on the metadata.

18. The method of claim 15, wherein the controlling of the application comprises inputting the screenshot and the metadata to at least one of input items of the application at least by using a trained editing model.

19. The method of claim 13, further comprising:
transmitting the screenshot and the metadata to an external electronic device connected to an electronic device that generated the screenshot based on an input received from a user.

20. The method of claim 19, wherein the transmitting to the external electronic device comprises transmitting the metadata related to user information signed in the electronic device to the external electronic device based on user information signed in the external electronic device.
